(19) United States
(12) Patent Application Publication
(10) Pub. No.: US 2026/0349131 A1
(43) Pub. Date: Nov. 5, 2026

(54) METHOD AND SYSTEM FOR RAPIDLY MEASURING TUNNEL BLASTING DAMAGE BASED ON WALL-CLIMBING ROBOT

(71) Applicant: Institute of Rock and Soil Mechanics, Chinese Academy of Sciences, Wuhan City (CN)

(72) Inventors: Xiaofeng LI, Wuhan City (CN); Haibo LI, Wuhan City (CN); Zhongwei JIANG, Wuhan City (CN); Peishuai CHEN, Wuhan City (CN); Fuquan JI, Wuhan City (CN)

(73) Assignee: Institute of Rock and Soil Mechanics, Chinese Academy of Sciences, Wuhan City (CN)

(21) Appl. No.: 19/578,959

(22) Filed: Mar. 26, 2026

(30) Foreign Application Priority Data
Apr. 26, 2025 (CN) CN202510533200.1

(51) Int. Cl. G01V 1/34; E21F 17/18; G01V 1/04; G01V 1/22; G01V 1/28; G01V 1/30

(52) U.S. Cl. CPC G01V 1/345; E21F 17/18; G01V 1/04; G01V 1/226; G01V 1/282; G01V 1/303

(57) ABSTRACT

A method for rapidly measuring tunnel blasting damage based on a wall-climbing robot includes following steps of arranging three-dimensional optical fiber network, recording coordinates of each segment of optical fiber, and establishing mapping relationship between optical fiber node and spatial coordinate position; constructing initial three-dimensional wave velocity model of tunnel rock mass; correcting velocity fields of reflected wave and diffracted wave, to obtain optimized wave velocity model; exciting artificial seismic sources at plurality of positions in the tunnel by the wall-climbing robot with vibration exciter, and performing data acquisition by DAS system through the optical fiber network; processing data acquired by the DAS system, performing wave field separation on reflected wave and the diffracted wave, and performing migration imaging on the reflected wave and the diffracted wave, respectively, after classification; and fusing imaging results of the reflected wave and the diffracted wave by weight coefficient to generate comprehensive geological model.

### TECHNICAL FIELD

The present disclosure relates to the technical field of tunnel engineering inspection, and in particular to a method and system for rapidly measuring tunnel blasting damage based on a wall-climbing robot.

### BACKGROUND

At present, tunnel engineering is gradually extending to deep and complex geological conditions. Under complex geological conditions, engineering disaster prevention and control has become a key technical challenge for the safe and efficient construction of deep engineering. The tunnel engineering requires frequent geological structure detection in the construction and operation stages, so there is an increasingly urgent demand for high-precision and high-efficiency detection technologies.

Common tunnel surrounding rock damage detection technologies include a ground penetrating radar, ultrasonic detection and tomography using transmitted waves. The ground penetrating radar is greatly affected by reinforcing steel bars inside a tunnel lining based on the principle of electromagnetic waves, so it is difficult to detect the structural defects of the surrounding rock inside the lining. The ultrasonic detection has become one of core methods for quantifying damage evolution in indoor rock loading tests based on the correlation between the characteristics of wave velocity, amplitude and frequency spectrum and the internal structural damage of materials when elastic waves are propagated in a rock medium. However, on construction sites with complex rock mass structures, an ultrasonic propagation path is susceptible to multiple scattering, resulting in a low signal-to-noise ratio and a complex wave velocity-stress relationship. The tomography using the transmitted waves mainly inverts a rock mass velocity model through the travel time of the transmitted waves, and a resolution thereof is limited by a wavelength and a ray coverage density: since the transmitted waves mainly reflect the macroscopic velocity change, when the defect structure feature is close to or less than the wavelength, the transmitted waves will cause signal distortion due to diffraction effect and scattering, resulting in low sensitivity to micro-defects such as small-scale cracks and cavities in the rock mass, and it is difficult to accurately image local anomalies in the complex rock mass, such as inclined faults or independent cavities.

Based on the limitation of a detection principle, the above detection technologies have difficulties and challenges from various perspectives for various geological structures such as faults, folds, joints, cavities and fractures, and the detection of tunnel linings and surrounding rock structures.

There is a solution in the prior art, which uses a reflected wave to perform three-dimensional tomographic migration imaging on a surrounding rock structure of a tunnel: ten geophones are arranged as receiving points across four cross sections in a cross plum blossom shape at the two sidewalls and a vault behind the tunnel, 12 seismic source points are symmetrically arranged in front of the tunnel close to two sidewalls of a tunnel face, seismic waves are excited by hammering with a sledge hammer, reflection point migration is achieved through three-dimensional tomography, and seismic signals of hazardous structures and water bodies in front of the tunnel face and the characteristics of geological bodies are detected. However, seismic migration based on reflected waves is primarily suitable for imaging stratigraphic interfaces with large-scale continuous structures, but exhibits poor imaging effect for small-scale heterogeneous bodies such as cracks and cavities commonly found in complex geological areas.

In addition, there is another solution in the prior art, which processes diffracted waves in seismic records by taking seismic diffracted scanning superimposition migration imaging as a basic principle and based on a common reflection surface stacking technique to obtain a high-precision seismic imaging section.

However, the above solutions are all based on a traditional detection method, in which the positions of the seismic source and the receiving point are fixed, so the vibration exciting position cannot be dynamically adjusted, resulting in a single seismic wave propagation path, a limited data coverage angle and low redundancy. Therefore, it is necessary to design a new method for rapidly measuring tunnel blasting damage so as to solve the above problems.

### SUMMARY

To achieve the above objective, the present disclosure adopts the following technical solution:
a method for rapidly measuring tunnel blasting damage based on a wall-climbing robot includes the following steps:
S1. arranging a three-dimensional optical fiber network, recording the coordinates of each segment of optical fiber, and establishing a mapping relationship between an optical fiber node and a spatial coordinate position;
S2. constructing an initial three-dimensional wave velocity model of a tunnel rock mass;
S3: performing velocity spectrum analysis on a reflected wave and performing local correction on a diffracted wave, respectively, to obtain an optimized wave velocity model;
S4. exciting artificial seismic sources at a plurality of positions in the tunnel by the wall-climbing robot with a vibration exciter, and performing data acquisition by a distributed fiber-optic acoustic sensing (DAS) system through the optical fiber network;
S5. processing data acquired in step S4, performing wave field separation on the reflected wave and the diffracted wave, and then performing migration imaging on the reflected wave and the diffracted wave, respectively; and
S6. fusing imaging results of the reflected wave and the diffracted wave by a weight coefficient to generate a comprehensive geological model.

Further, step S2 specifically includes the following steps:
S21. measuring a wave velocity of a tunnel lining material in a laboratory to serve as an initial model reference value;
S22. performing laboratory test on a drill core to obtain densities and wave velocities of different lithologies, correlating core data with the position of a drill spiral optical fiber, and establishing an initial vertical velocity gradient model;
S23. dividing a tunnel wall into a plurality of grids, moving the wall-climbing robot to a center point of each grid according to a preset path, starting an electromagnetic vibration exciter to generate an artificial seismic source, acquiring data by the DAS system through the optical fiber network after each excitation, and recording the arrival time of a first-arrival wave at each optical fiber node to serve as first-arrival wave travel time data; and
S24. using a simultaneous iterative reconstruction technique to invert a large-scale velocity field of the rock mass to generate a three-dimensional wave velocity model.

Further, in step S24, when the simultaneous iterative reconstruction technique is used, an iterative formula is as follows:

$${v}_{k + 1} = {v}_{k} + {λ}_{k} \cdot Ω \cdot {G}^{T} \cdot {Λ}^{- 1} \cdot ( {t}_{o b s} - \frac{G}{{v}_{k}} ) \qquad ( 1 )$$

a convergence condition is:

$$\frac{{‖ {t}_{obs} - \frac{G}{{v}_{k}} ‖}_{2}}{{‖ {t}_{obs} ‖}_{2}} ⩽ ε \qquad ( 2 )$$

in the formula, vₖ is a three-dimensional wave velocity field model of a k^{th} iteration, and an initial value wave velocity field v₀ is derived from drill core data and a lining material calibration value;
λₖ is an adaptive step length factor, that is, a dynamic attenuation coefficient for balancing a convergence velocity and a stability, λ₀ is an initial step length, and β is an attenuation rate;
Ω is a weight matrix which is a diagonal matrix with a dimension of A×A, A is the total number of rays, any element is expressed as

$${Ω}_{i i} = \frac{1}{\sqrt{{\sum }_{j} {G}_{i j}^{2} + γ}} ,$$

and γ=0.2 drill fracture density;
G is a ray path matrix which is a sparse matrix with a dimension of A×B, B is the total number of grids and used to describe a propagation path length of rays in the grids, an element G is a path length of an i^{th} ray in a j^{th} grid, and the ray path matrix G is generated based on the coordinates of a vibration exciting point of the wall-climbing robot and the optical fiber node through ray tracing;
Λ is a path normalization matrix, and a diagonal element is a total path length ΣⱼGᵢⱼ of each ray and used to eliminate the influence of the ray path on a residual;
t_{obs} is first-arrival wave travel time data measured by the DAS system, and F is a convergence threshold;
when the initial three-dimensional wave velocity model is generated, specific steps are as follows:
inputting the first-arrival wave travel time data t_{obs}, the ray path matrix G and the initial wave velocity field v₀ in an initial state, setting values of λ₀, β, γ and ε, and calculating the matrices Ω and Λ; and
calculating a residual

$${r}_{k} = {t}_{o b s} - \frac{G}{{v}_{k}} ,$$

calculating an updating quantity Δvₖ=λₖ·Ω·G^{T}·Λ⁻¹·rₖ, iteratively updating the wave velocity field vₖ₊₁=vₖ+Δvₖ, if not meeting the convergence condition of formula (2), continuing iteration until meeting the convergence condition of formula (2), outputting the current vₖ₊₁ to serve as the initial three-dimensional wave velocity model, and ending iteration.

Further, in step S3, when the velocity field of the reflected wave is corrected, specific steps are as follows:
dividing reflected wave data into a plurality of common midpoint gathers based on the symmetrical distribution of the vibration exciting point and a receiving point, where the position of each common midpoint is the center of the position of the vibration exciting point of the wall-climbing robot and the position of the receiving point in the optical fiber network, and each common midpoint gather corresponds to a reflected signal set of a specific area in front of the tunnel;
calculating superimposed energy corresponding to each candidate velocity through velocity scanning, and selecting a velocity corresponding to maximum energy as an optimal layer velocity of the current common midpoint, where a reflected wave velocity spectrum analysis formula is:

$$E ( V ) = {\sum }_{m = 1}^{M} {( {\sum }_{n = 1}^{N} {A}_{m n} \cdot δ ( {t}_{m n} - \sqrt{{t}_{0}^{2} + \frac{{x}_{n}^{2}}{{V}^{2}}} ) )}^{2} \qquad ( 3 )$$

in the formula, V is the candidate velocity, that is, a layer velocity value to be evaluated, E(V) is the superimposed energy corresponding to the candidate velocity V and used to evaluate the rationality of the velocity, M is the number of the common midpoint gathers, N is the number of seismic traces that each common midpoint gather comprises, Aₘₙ is an amplitude value in an n^{th} trace of seismic record in an m^{th} common midpoint gather and is directly measured by the DAS system, tₘₙ is the arrival time of an n^{th} trace of seismic wave in the m^{th} common midpoint gather, to is the two-way time of the wave vertically incident to a reflecting interface from each common midpoint and back, xₙ is an offset distance, that is, a horizontal distance between a seismic source in the n^{th} trace of seismic record and the receiving point, δ is a pulse function and is used to align with a corrected waveform, δ is 1 only when time alignment and otherwise is 0, and
the convergence condition is: after a single-layer velocity is corrected, a change rate of the reflected wave superimposed energy is less than a convergence threshold κ, that is,

$$\frac{‖ {E ( V )}_{k + 1} - {E ( V )}_{k} ‖}{‖ {E ( V )}_{k} ‖} ⩽ κ ;$$

and
sequentially optimizing the velocity model from a shallow layer to a deep layer by a layer stripping method, recalculating the superimposed energy after each update until the velocity of each layer converges, and generating a calibrated velocity field of the reflected wave.

Further, in step S3, when the velocity field of the diffracted wave and is corrected, specific steps are as follows:
separating the diffracted wave by a polarization angle threshold, retaining a scattered signal with a polarization angle greater than 30°, and inhibiting reflected wave interference;
calculating a travel time residual of the diffracted wave by the following formula to compare measured travel time of the diffracted wave with predicted travel time of the current velocity field:

$$Δ t = {t}_{o b s} - \frac{{L}_{r a y}}{{V}_{c u r r e n t}} \qquad ( 4 )$$

where in the formula, t_{obs} is the measured travel time of the diffracted wave measured by the DAS system, L_{ray} is a propagation path length of the diffracted wave and is calculated through ray tracing, and V_{current} is a local velocity of the current velocity field;
based on regularized least squares inversion, if the travel time residual of the diffracted wave is greater than a preset threshold, indicating that the local velocity is anomalous, updating the local velocity anomalous area, and performing simultaneous iterative reconstruction technique migration imaging by using a corrected local velocity field; and
in step S3, after correcting the velocity fields of the reflected wave and the diffracted wave, fusing the corrected local velocity field of the diffracted wave and the calibrated velocity field of the reflected wave to generate an optimized wave velocity model.

Further, in step S4, specifically, based on the grids divided in step S23, the tunnel wall is divided into a plurality of finer grids, the wall-climbing robot moves to each grid midpoint according to a preset path, the electromagnetic vibration exciter is started to generate the artificial seismic source, after each vibration excitation, the DAS system records full waveform data of the optical fiber network, including a direct wave, the reflected wave and the diffracted wave, and the vibration exciting time of the robot and the acquisition time of the DAS system are synchronized by an optical fiber timing technology.

Further, step S5 specifically includes the following steps:
first, preprocessing data, determining the arrival time of the first-arrival wave by detecting a mutation point of a waveform amplitude, eliminating a delayed signal and non-seismic source interference, and performing data denoising and signal gain;
then, separating the reflected wave and the diffracted wave, separating the diffracted wave based on the polarization angle threshold, retaining a scattered signal with a polarization angle greater than 30°, retaining a nearly vertical incident component of the reflected wave, filtering out a high-frequency diffracted wave component in a frequency-wave number domain, and retaining a low-frequency reflected wave signal;
when performing reflected wave migration imaging, according to the optimized wave velocity model obtained in step S3, weighting and superimposing the reflected wave amplitude to an imaging point according to the travel time and by a Kirchhoff integral method, as the following formula:

$${I}_{reflection} ( x , z ) = {\sum }_{i = 1}^{N} \frac{{A}_{i}}{\sqrt{V ( x , z ) \cdot {t}_{i}}} \cdot δ ( {t}_{i} - \frac{{r}_{s i} + {r}_{r i}}{V ( x , z )} ) \qquad ( 5 )$$

wherein in the formula, Aᵢ is a reflected wave amplitude from a seismic source point Sᵢ to a receiving point Rᵢ, rₛᵢ is a distance from the seismic source point Sᵢ to an imaging point (x, z), rᵣᵢ is a distance from the receiving point Rᵢ to the imaging point (x, z), and V(x, z) is a calibrated velocity field;
analyzing a dynamic optimization velocity field by a residual curvature until the imaging of the reflecting interface is clear;
when performing diffracted wave migration imaging, according to the optimized wave velocity model obtained in step S3, accurately capturing an asymmetric path of the diffracted wave by a reverse-time migration algorithm and through full-wave field forward-backward propagation interference imaging, as the following formula:

I_{diffraction}(x,z)=Σₜ[forward−propagated wave field(x,z,t)·backward−propagated wave field(x,z,t)] (6)
where in the formula, a forward-propagated wave field refers to a wave field propagated forward from the seismic source point, and a backward-propagated wave field is a wave field propagated backward from the receiving point; and
subsequently, correcting the local velocity, for a diffracted imaging blurred area, inverting local velocity anomaly based on the travel time residual, and performing migration imaging again after updating.

Further, in step S6, imaging results of the reflected wave and the diffracted wave are fused by a weight coefficient to generate a comprehensive geological model, as the following formula:

I_{final}(x,Z)=α·I_{refection}(x,Z)+βI_{diffraction}·(x,z) (7)
in the formula, α and β are weight coefficients, and α+β=1.

Another aspect of the present disclosure provides a system for rapidly measuring tunnel blasting damage based on a wall-climbing robot, using the above method for rapidly measuring tunnel blasting damage based on a wall-climbing robot and including a DAS system and the wall-climbing robot, where
the DAS system includes an optical fiber network and a demodulator, the optical fiber network is configured to receive a vibration signal, and the demodulator is configured to extract related information by analyzing a waveform of the vibration signal;
the wall-climbing robot includes a main body, and a plurality of rotor wings, a plurality of driving wheels, a vacuum pump and a vibration exciter which are mounted on the main body; and
the rotor wings and the vacuum pump are, respectively, configured to provide a lift force and an adsorption force, the plurality of driving wheels are used for the wall-climbing robot to walk on a tunnel wall, and the vibration exciter is configured to generate an artificial seismic source.

Further, the wall-climbing robot is further provided with a navigation module, a camera module and a data transmission module;
the navigation module is configured to plan a movement path, the camera module is configured to identify the quality of a lining on a surface of a tunnel, and the data transmission module is configured to achieve remote control and transmit navigation information and video information to a mobile terminal in real time;
the optical fiber network includes circumferential optical fibers, longitudinal optical fibers and spiral winding optical fibers;
the circumferential optical fibers are arranged at equal intervals in a circumferential direction of the tunnel wall to form a closed ring and cover the full cross-section of the tunnel;
the longitudinal optical fibers are arranged in parallel in an axial direction of the tunnel and orthogonal to the circumferential optical fibers to form a grid; and
when the spiral winding optical fibers are arranged, the tunnel wall is drilled first, and then the optical fibers are embedded into drill holes in a spiral winding manner.

Compared with the prior art, the method and system for rapidly measuring tunnel blasting damage based on the wall-climbing robot provided by the present disclosure uses the three-dimensional optical fiber network to receive waveform data of the tunnel rock mass instead of the traditional geophone (that is, a point sensor), the defect of insufficient radial sensitivity of the optical fiber is overcome through the optical fiber network with circumferential+longitudinal+drill spiral layout, the high-density characteristic of DAS data can greatly increase spatial resolution, and the problem of insufficient spatial coverage rate of the traditional geophone is effectively solved; furthermore, the wall-climbing robot is used to perform omni-directional dynamic vibration excitation on the tunnel wall; compared with the traditional method of arranging very few fixed seismic source points on the side wall of the tunnel, the introduction of the wall-climbing robot can achieve dynamic vibration excitation and full cross-section coverage of vibration exciting points of the tunnel; meanwhile, in combination with the three-dimensional optical fiber network, a high-density data coverage network can be formed and multi-angle data fusion can be achieved, so that the precision of the wave velocity field model and the accuracy of inverted data are greatly improved, and the method is significantly better than the traditional method in economy and efficiency.

In addition, the traditional method depends on a single waveform for inversion and migration imaging of the tunnel surrounding rock, and only supports the detection of large-scale structures or small-scale defects; compared with the traditional method, the present disclosure is as follows: the reflected wave and the diffracted wave are separated after receiving full waveform data, migration imaging is performed, respectively, and then the reflected wave imaging (large-scale structure) and the diffracted wave imaging (small-scale defect) are superimposed to form the comprehensive geological model, the imaging requirements of the large-scale structure and the small-scale heterogeneous body, that is, macro and micro, can be considered, and the detection comprehensiveness of the complex geological area is significantly improved.

### BRIEF DESCRIPTION OF THE DRAWINGS

FIG. 1 is a schematic diagram of a system for rapidly measuring tunnel blasting damage based on a wall-climbing robot according to the present disclosure;

FIG. 2 is a schematic diagram of an optical fiber network and a wall-climbing robot in a tunnel;

FIG. 3 is a schematic diagram of a spiral winding optical fiber and a protective sleeve;

FIG. 4 is a structural schematic diagram of a wall-climbing robot; and

FIG. 5 is a schematic flowchart of a method for rapidly measuring tunnel blasting damage based on a wall-climbing robot according to the present disclosure.

### DESCRIPTION OF REFERENCE NUMERALS

10. wall-climbing robot; 11. main body; 12. rotor wing; 13. driving wheel; 14. vacuum pump; 15. vibration exciter; 16. camera module; 20. optical fiber network; 21. circumferential optical fiber; 22. longitudinal optical fiber; 23. spiral winding optical fiber; 24. protective sleeve; 30. demodulator; 40. receiving point; 50. anomalous geological body boundary; 60. ellipsoid.

### DETAILED DESCRIPTION OF THE EMBODIMENTS

In order to make the technical means, creative features, achieved objective and efficacy of the present disclosure easy to understand, the present disclosure will be further described with reference to the following embodiments.

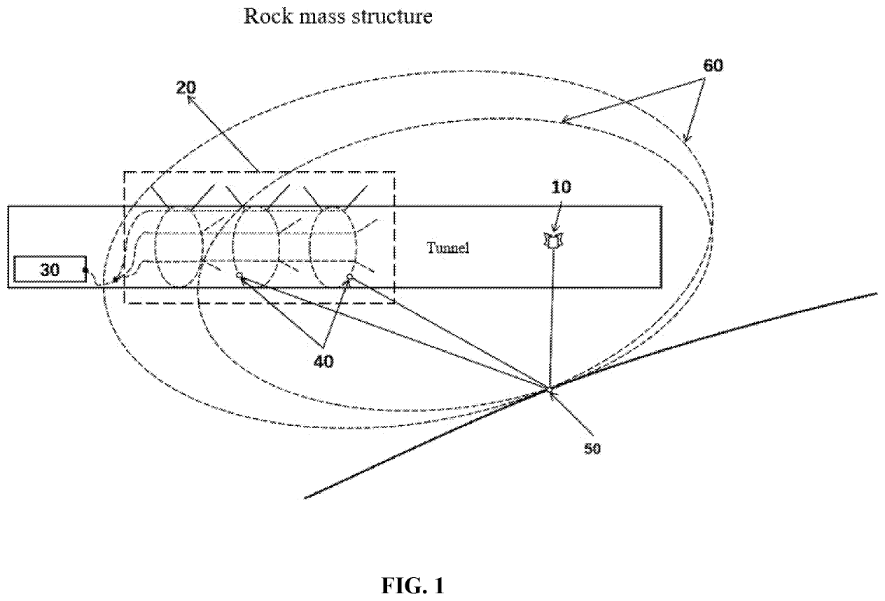

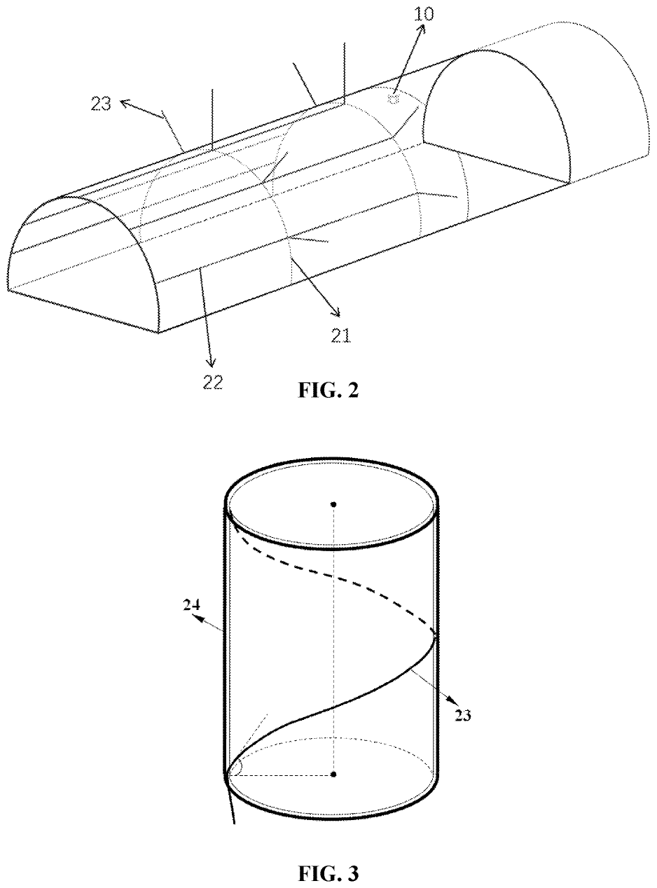

The present disclosure provides a method and system for rapidly measuring tunnel blasting damage based on a wall-climbing robot. In a specific embodiment, referring to FIG. 1 and FIG. 2, the system for rapidly measuring tunnel blasting damage based on the wall-climbing robot includes a DAS system and the wall-climbing robot 10.

The DAS system includes an optical fiber network 20 and a demodulator 30; the optical fiber network 20 communicates with the demodulator 30 through an optical fiber; the optical fiber network is configured to receive a vibration signal; each segment of optical fiber in the optical fiber network 20 can be regarded as an independent sensor for receiving the vibration signal; and the demodulator 30 can extract relevant information such as amplitude, frequency, velocity and acceleration by analyzing the waveform of the vibration signal.

The optical fiber network 20 includes circumferential optical fibers 21, longitudinal optical fibers 22 and spiral winding optical fibers 23; the circumferential optical fibers 21 are arranged at equal intervals in a circumferential direction of the tunnel wall to form a closed ring and cover the full cross-section of the tunnel; the longitudinal optical fibers 22 are arranged in parallel in an axial direction of the tunnel and orthogonal to the circumferential optical fibers 21 to form a grid; and when the spiral winding optical fibers 23 are arranged, the tunnel wall is drilled first, and then the optical fibers are embedded into drill holes in a spiral winding manner. In addition, an outer layer of each optical fiber can be covered with a protective sleeve 24 to prevent construction damage, and a structure formed by the spiral winding optical fibers 23 and the protective sleeve 24 is shown in FIG. 3.

In this embodiment, the DAS system, based on a time-gated digital optical frequency domain reflectometry (TGD-OFDR) technology, is configured to record a direct wave signal (arrival time of P wave) at each monitoring point on the longitudinal optical fibers 22, transverse optical fibers and the spiral winding optical fibers 23 in the optical fiber network and receive reflected wave and diffracted wave signals in a surrounding rock area to be measured.

In FIG. 1, which shows the basic principle of the three-dimensional tomography of a tunnel seismic wave, the wall-climbing robot 10 performs vibration excitation at the position shown in the figure, and the position is a seismic point. The figure shows two receiving points 40 in the optical fiber network 20 and also shows an anomalous geological body boundary 50. It may be understood that the anomalous geological body boundary 50 in the figure can be replaced with any reflecting body or winding point. For any pair of seismic source point and receiving point 40, an ellipsoid 60 can be defined in combination with the position of the reflecting body or the winding point.

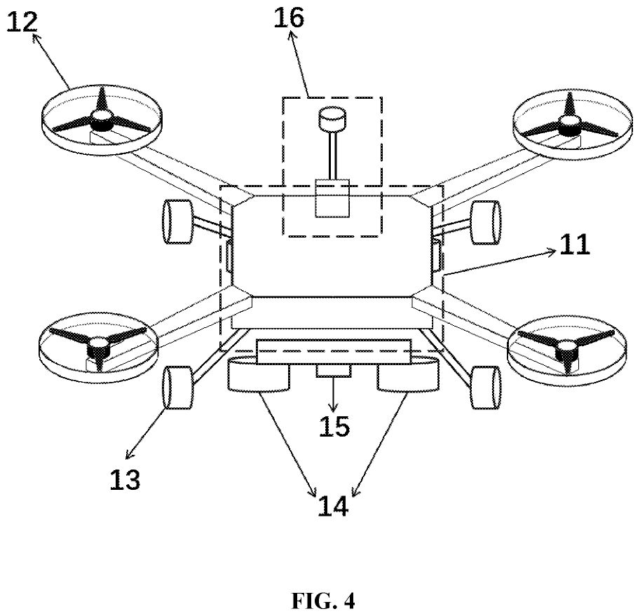

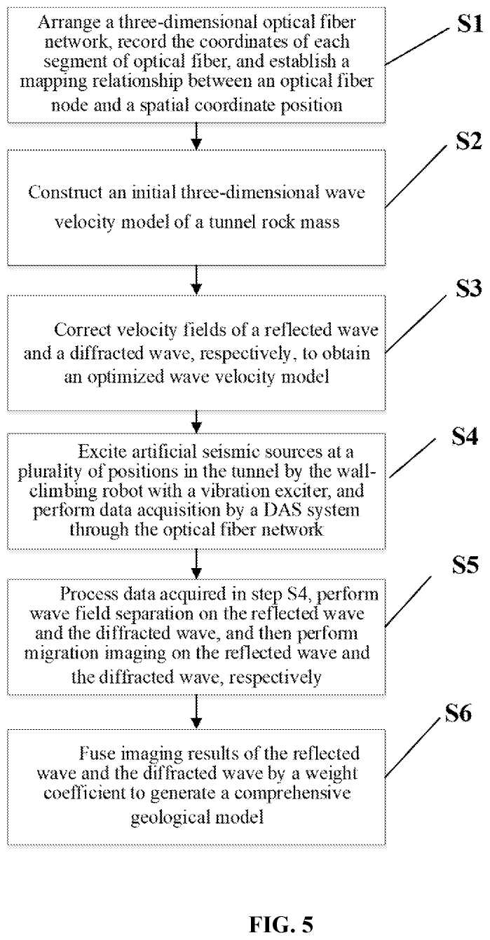

In this embodiment, as shown in FIG. 4, the wall-climbing robot 10 includes a main body 11, and a plurality of rotor wings 12, a plurality of driving wheels 13, a vacuum pump 14 and a vibration exciter 15 (an electromagnetic vibration exciter) which are mounted on the main body 11; the rotor wings 12 and the vacuum pump 14 are, respectively, configured to provide a lift force and an adsorption force, the plurality of driving wheels 13 are used for the wall-climbing robot 10 to walk on a tunnel wall, and the vibration exciter 15 is configured to generate an artificial seismic source.

Further, the wall-climbing robot 10 is further provided with a navigation module, a camera module 16 and a data transmission module; the navigation module is configured to plan a movement path and accurately detect a vibration excitation blind area of the tunnel; the camera module 16 is configured to identify the quality of a lining on a surface of the tunnel and increase a defect determination accurate rate, and is further configured to determine the surface quality of the surrounding rock; and the data transmission module is configured to achieve remote control and transmit navigation information and video information to a mobile terminal in real time. The wall-climbing robot 10 wirelessly interacts with the mobile terminal through the data transmission module, so that parameters of the vibration exciter 15 can be adjusted remotely.

Referring to FIG. 5, the present disclosure further provides a method for rapidly measuring tunnel blasting damage based on a wall-climbing robot, including the following steps:
S1. a three-dimensional optical fiber network 20 is arranged, the coordinates of each segment of optical fiber are recorded, and a mapping relationship between an optical fiber node and a spatial coordinate position is established;
S2. an initial three-dimensional wave velocity model of a tunnel rock mass is constructed;
S3: velocity fields of a reflected wave and a diffracted wave are corrected, respectively, to obtain an optimized wave velocity model;
S4. artificial seismic sources are excited at a plurality of positions in the tunnel by the wall-climbing robot 10 with a vibration exciter 15, and a DAS system performs data acquisition through the optical fiber network 20;
S5. data acquired in step S4 is processed, wave field separation is performed on the reflected wave and the diffracted wave, and then migration imaging is performed on the reflected wave and the diffracted wave, respectively; and
S6. fusing imaging results of the reflected wave and the diffracted wave by a weight coefficient to generate a comprehensive geological model.

In a specific embodiment:
in step S1, specifically, when a three-dimensional optical fiber network 20 is arranged, optical fibers are arranged at equal intervals in a circumferential direction of a tunnel wall to form a closed ring and cover the full cross-section of the tunnel; a plurality of optical fibers are arranged in parallel in an axial direction of the tunnel and orthogonal to circumferential optical fibers 21 to form a grid; and the tunnel wall is drilled, the optical fibers are embedded into the drill hole at a certain angle in a spiral winding manner to form the three-dimensional optical fiber network 20, so that the problem that the optical fibers are insensitive to radial vibration is effectively solved. Then the optical fibers are fixed by using a special coupling agent such as epoxy resin to avoid looseness, and an outer layer is covered with a protective sleeve 24 to avoid construction damage. Further, the optical fiber connectivity can be detected by a TGD-OFDR reflectometer to ensure that the optical fiber network 20 has not breaking points. Finally, the coordinates of each segment of optical fiber are measured and recorded by a total station, and a mapping relationship between an optical fiber node and a spatial coordinate position is established.

In step S2, when the initial three-dimensional wave velocity model is constructed, specific steps are as follows:
S21. a wave velocity of a tunnel lining material is measured in a laboratory to serve as an initial model reference value;
S22. laboratory test is performed on a drill core to obtain densities and wave velocities of different lithologies, core data is correlated with the position of a drill spiral optical fiber, and an initial vertical velocity gradient model is established;
S23. the tunnel wall is divided into a plurality of grids, the grid size is determined based on the balance of the main wavelength of the seismic source, the spatial resolution and the calculation efficiency, as the construction of an initial model, a relatively thick grid (such 5 m×5 m) can be used to improve the calculation efficiency, but it should not be greater than half of the expected size of a detection target (such as a large fissure zone) and less than a minimum curvature radius of a main reflecting interface in the transverse direction so as to ensure the wave velocity inversion can capture the change of the large-scale speed structure. The wall-climbing robot 10 moves to each grid midpoint according to a preset path, a vibration exciter 15 is started to generate an artificial seismic source, a specific vibration exciting frequency and energy are adjusted dynamically according to the detection target, a deep large-scale structure uses a vibration exciting seismic source with low frequency and high energy to enhance the penetrability, and a shallow fine defect uses a higher frequency to increase the resolution. Data is acquired by the DAS system through the optical fiber network 20 after each excitation, and the arrival time of a first-arrival wave at each optical fiber node is recorded as first-arrival wave travel time data.

S24. a simultaneous iterative reconstruction technique is used to invert a large-scale velocity field of the rock mass to generate a three-dimensional wave velocity model.

Further, in step S24, when the simultaneous iterative reconstruction technique is used, an iterative formula is as follows:

$${v}_{k + 1} = {v}_{k} + {λ}_{k} \cdot Ω \cdot {G}^{T} \cdot {Λ}^{- 1} \cdot ( {t}_{o b s} - \frac{G}{{v}_{k}} ) \qquad ( 1 )$$

a convergence condition is:

$$\frac{{‖ {t}_{o b s} - \frac{G}{{v}_{k}} ‖}_{2}}{{‖ {t}_{o b s} ‖}_{2}} ⩽ ε \qquad ( 2 )$$

in the formula, vₖ is a three-dimensional wave velocity field model of a k^{th} iteration, and an initial value wave velocity field v₀ is derived from drill core data and a lining material calibration value;
λₖ is an adaptive step length factor, that is, a dynamic attenuation coefficient for balancing a convergence velocity and a stability, λ₀ is an initial step length, and β is an attenuation rate;
Ω is a weight matrix which is a diagonal matrix with a dimension of A×A, A is the total number of rays, that is, the number of ray paths between all the vibration exciting points and the receiving points, any element is expressed as

$${Ω}_{i i} = \frac{1}{\sqrt{{\sum }_{j} {G}_{i j}^{2} + γ}} ,$$

and γ=0.2·drill fracture density;
G is a ray path matrix which is a sparse matrix with a dimension of A×B, B is the total number of grids and used to describe a propagation path length of rays in the grids, an element Gᵢⱼ is a path length of an i^{th} ray in a j^{th} grid, and the ray path matrix G is generated based on the coordinates of a vibration exciting point of the wall-climbing robot 10 and the optical fiber node through ray tracing;
Λ is a path normalization matrix, and a diagonal element is a total path length EⱼGᵢⱼ of each ray and used to eliminate the influence of the ray path on a residual; and
t_{obs} is first-arrival wave travel time data measured by the DAS system, and F is a convergence threshold.

When the initial three-dimensional wave velocity model is generated, specific steps are as follows:
the first-arrival wave travel time data t_{obs}, the ray path matrix G and the initial wave velocity field v₀ are input in an initial state, values of λ₀, β, γ and ε are set, and the matrices Ω and Λ are calculated, where in this embodiment, an initial step length Λ0=1.0, an attenuation rate β=0.05, γ=0 0.1, ε=1%;
a residual

$${r}_{k} = {t}_{o b s} - \frac{G}{{v}_{k}}$$

is calculated, an updating quantity Δvₖ=λₖ·Ω·G^{T}·Λ⁻¹·rₖ is calculated, the wave velocity field vₖ₊₁=vₖ+Δvₖ is iteratively updated, if the convergence condition of formula (2) is not met, iteration is continued until meeting the convergence condition of formula (2), the current vₖ₊₁ is output as the initial three-dimensional wave velocity model, and iteration is ended.

In step S3, velocity fields of a reflected wave and a diffracted wave are corrected, respectively, to obtain an optimized wave velocity model. Reflected wave imaging depends on a velocity model with a large-scale layered structure. If the initial velocity field error is large, the position offset of the reflecting interface or blurred imaging will be caused, so interlayer velocity optimization is required. The diffracted wave is generated by small-scale defects such as fractures and cavities, and the propagation paths are affected by local velocity anomalies. The traditional velocity field (based on the reflected wave or the first-arrival wave) may ignore the local velocity mutation, resulting in blurred imaging or positioning deviation of the diffracted wave, so targeted correction is required.

Further, when the velocity field of the reflected wave is corrected, specific steps are as follows:
reflected wave data is divided into a plurality of common midpoint (CMP) gathers based on the symmetrical distribution of the vibration exciting point and a receiving point, where the position of each common midpoint is the center of the position of the vibration exciting point of the wall-climbing robot 10 and the position of the receiving point 40 in the optical fiber network 20, and each common midpoint gather corresponds to a reflected signal set of a specific area in front of the tunnel;
superimposed energy corresponding to each candidate velocity is calculated through velocity scanning, and a velocity corresponding to maximum energy is selected as an optimal layer velocity of the current common midpoint, where a reflected wave velocity spectrum analysis formula is:

$$E ( V ) = {\sum }_{m = 1}^{M} {( {\sum }_{n = 1}^{N} {A}_{m n} \cdot δ ( {t}_{m n} - \sqrt{{t}_{0}^{2} + \frac{{x}_{n}^{2}}{{V}^{2}}} ) )}^{2} \qquad ( 3 )$$

in the formula, V is the candidate velocity, that is, a layer velocity value to be evaluated, the scanning range is usually ±20% of the initial velocity, E(V) is the superimposed energy corresponding to the candidate velocity V and used to evaluate the rationality of the velocity, M is the number of the common midpoint gathers, N is the number of seismic traces that each common midpoint gather includes (that is, receiving signals with different offset distances), Aₘₙ is an amplitude value in an n^{th} trace of seismic record in an m^{th} common midpoint gather and is directly measured by the DAS system, tₘₙ is the arrival time of an n^{th} trace of seismic wave in the m^{th} common midpoint gather, to is the two-way time of the wave vertically incident to a reflecting interface from each common midpoint and back, xₙ is an offset distance, that is, a horizontal distance between a seismic source in the n^{th} trace of seismic record and the receiving point, δ is a pulse function and is used to align with a corrected waveform, δ is 1 only when time alignment and otherwise is 0, and
the convergence condition is: after a single-layer velocity is corrected, a change rate of the reflected wave superimposed energy is less than a convergence threshold κ, that is,

$$\frac{‖ {E ( V )}_{k + 1} - {E ( V )}_{k} ‖}{‖ {E ( V )}_{k} ‖} ⩽ κ ;$$

and
the velocity model is optimized sequentially from a shallow layer to a deep layer by a layer stripping method, the superimposed energy is recalculated after each update until the velocity of each layer converges, and a calibrated velocity field of the reflected wave is generated.

The reflected wave velocity spectrum analysis corrects the background velocity error of the layered structure, thereby ensuring the accurate imaging of large-scale structures such as faults and rock interfaces.

On the other hand, when the velocity field of the diffracted wave and is corrected, specific steps are as follows:
the diffracted wave is separated by a polarization angle threshold, a scattered signal with a polarization angle greater than 30° is retained, and reflected wave interference is inhibited, where the polarization angle refers to an included angle between a vibration direction of the seismic wave and a tunnel axis and is used to distinguish the reflected wave (near vertical incidence, small polarization angle) from the diffracted wave (scattering propagation, large polarization angle);
a travel time residual of the diffracted wave is calculated by the following formula to compare measured travel time of the diffracted wave with predicted travel time of the current velocity field:

$$Δ t = {t}_{o b s} - \frac{{L}_{ray}}{{V}_{current}} \qquad ( 4 )$$

where in the formula, t_{obs} is the measured travel time of the diffracted wave measured by the DAS system, L_{ray} is a propagation path length of the diffracted wave and is calculated through ray tracing, and V_{current} is a local velocity of the current velocity field;
based on regularized least squares inversion, if the travel time residual of the diffracted wave is greater than a preset threshold, it is indicated that the local velocity is anomalous, the local velocity anomalous area is updated, and reverse-time migration imaging is performed by using a corrected local velocity field; and
in step S3, after correcting the velocity fields of the reflected wave and the diffracted wave, the corrected local velocity field of the diffracted wave and the calibrated velocity field of the reflected wave are fused to generate an optimized wave velocity model.

In step S4, artificial seismic sources are excited at a plurality of positions in the tunnel by the wall-climbing robot 10 with a vibration exciter 15, and a DAS system performs data acquisition through the optical fiber network 20.

Specifically, based on the grids divided in step S23, to obtain imaging data with high resolution, the tunnel wall is divided into a plurality of finer grids, the basis of the fine grid division should be less than the minimum defect (such as small fractures or cavities) size of target detection; and to meet the spatial sampling theorem, it should be less than a quarter of a wavelength corresponding to a highest effective signal frequency, thereby avoiding spatial aliasing in imaging. The wall-climbing robot 10 moves to each grid midpoint according to a preset path, a vibration exciter 15 is started to generate an artificial seismic source, a specific vibration exciting frequency and energy are adjusted dynamically according to the detection target, a deep large-scale structure uses a vibration exciting seismic source with low frequency and high energy to enhance the penetrability, and a shallow fine defect uses a higher frequency to increase the resolution. After each vibration excitation, the DAS system records full waveform data of the optical fiber network 20, including a direct wave, the reflected wave and the diffracted wave, and the vibration exciting time of the robot and the acquisition time of the DAS system are synchronized by an optical fiber timing technology.

In step S5, data acquired in step S4 is processed, wave field separation is performed on the reflected wave and the diffracted wave, and then migration imaging is performed on the reflected wave and the diffracted wave, respectively. Specific steps are as follows:
first, data is preprocessed, the arrival time of the first-arrival wave is determined by detecting a mutation point of a waveform amplitude, a delayed signal and non-seismic source interference are eliminated, and data denoising and signal gain are performed.

The preprocessing specifically includes the following steps: first, an original signal acquired by the DAS system is subjected to decoding and format standardization, the time of each trace is synchronized by optical fiber timing; then, the first-arrival wave is automatically picked by an AIC algorithm, the statistic distribution of the amplitudes and travel time of all traces is calculated, and the traces with anomalous amplitude or the travel time significantly deviating from the group are removed; next, a multi-stage cascaded filtering strategy combining band-pass filtering with a spatial domain FK filtering and median filtering is used to suppress different types of noise; afterwards, spherical diffusion compensation and inverse Ω filtering are performed to restore a wave field amplitude; and finally, the data is rearranged into a common shot gather, and the direct wave is eliminated in a time window, thereby providing preprocessed wave field data for the subsequent separation of the reflected wave and the diffracted wave and migration imaging.

Then, the reflected wave and the diffracted wave are separated, the diffracted wave is separated based on the polarization angle threshold, a scattered signal with a polarization angle greater than 300 is retained, a nearly vertical incident component of the reflected wave is retained, a high-frequency diffracted wave component is filtered out in a frequency-wave number domain, and a low-frequency reflected wave signal is retained.

When reflected wave migration imaging is performed, according to the optimized wave velocity model obtained in step S3, a Kirchhoff integral method is used, where the Kirchhoff integral method is suitable for imaging of the reflecting interface with the layered structure, has high calculation efficiency and is adapted to large-scale structure detection; and the reflected wave amplitude is weighted and superimposed to an imaging point according to the travel time, as the following formula:

$${I}_{reflection} ( x , z ) = {\sum }_{i = 1}^{N} \frac{{A}_{i}}{\sqrt{V ( x , z ) \cdot {t}_{i}}} \cdot δ ( {t}_{i} - \frac{{r}_{s i} + {r}_{r i}}{V ( x , z )} ) \qquad ( 5 )$$

where in the formula, Aᵢ is a reflected wave amplitude from a seismic source point Sᵢ to a receiving point Rᵢ, rₛᵢ is a distance from the seismic source point Sᵢ to an imaging point (x,z), rᵣᵢ is a distance from the receiving point Rᵢ to the imaging point (x, z), and V(x, z) is a calibrated velocity field.

Then, a dynamic optimization velocity field is analyzed by a residual curvature until the imaging of the reflecting interface is clear.

When diffracted wave migration imaging is performed, according to the optimized wave velocity model obtained in step S3, a reverse-time migration algorithm which can capture the asymmetric propagation path and accurately position small-scale defects such as fractures and cavities is used to accurately capture an asymmetric path of the diffracted wave through full-wave field forward-backward propagation interference imaging, as the following formula:

I_{diffraction}(x,z)=Σₜ[forward−propagated wave field(x,z,t)·backward−propagated wave field(x,z,t)] (6)
where in the formula, a forward-propagated wave field refers to a wave field propagated forward from the seismic source point, and a c is a wave field propagated backward from the receiving point.

Subsequently, the local velocity is corrected, for a diffracted imaging blurred area, local velocity anomaly is inverted based on the travel time residual, and migration imaging is performed again after updating.

In step S6, imaging results of the reflected wave and the diffracted wave are fused by a weight coefficient to generate a comprehensive geological model, as the following formula:

I_{final}(x,z)=α·I_{reflection}(x,Z)+β·I_{diffraction}·(x,z) (7)

In the formula, α and β are weight coefficients, for α+β, α=0.7 and β=0.3, and the values of α and β can be adjusted dynamically according to the signal-to-noise ratio.

In conclusion, the method and system for rapidly measuring tunnel blasting damage based on the wall-climbing robot provided by the present disclosure uses the three-dimensional optical fiber network 20 to receive waveform data of the tunnel rock mass instead of the traditional geophone (that is, a point sensor), the defect of insufficient radial sensitivity of the optical fiber is overcome through the optical fiber network 20 with circumferential+longitudinal+drill spiral layout, the high-density characteristic of DAS data can greatly increase spatial resolution, and the problem of insufficient spatial coverage rate of the traditional geophone is effectively solved; furthermore, the wall-climbing robot 10 is used to perform omni-directional dynamic vibration excitation on the tunnel wall; compared with the traditional method of arranging very few fixed seismic source points on the side wall of the tunnel, the introduction of the wall-climbing robot 10 can achieve dynamic vibration excitation and full cross-section coverage of vibration exciting points of the tunnel; meanwhile, in combination with the three-dimensional optical fiber network 20, a high-density data coverage network can be formed and multi-angle data fusion can be achieved, so that the precision of the wave velocity field model and the accuracy of inverted data are greatly improved, and the method is significantly better than the traditional method in economy and efficiency.

In addition, the traditional method depends on a single waveform for inversion and migration imaging of the tunnel surrounding rock, and only supports the detection of large-scale structures or small-scale defects; compared with the traditional method, the present disclosure is as follows: the reflected wave and the diffracted wave are separated after receiving full waveform data, migration imaging is performed, respectively, and then the reflected wave imaging (large-scale structure) and the diffracted wave imaging (small-scale defect) are superimposed to form the comprehensive geological model, the imaging requirements of the large-scale structure and the small-scale heterogeneous body, that is, macro and micro, can be considered, and the detection comprehensiveness of the complex geological area is significantly improved.

Finally, it should be noted that the above embodiments are merely used to explain the technical solutions of the present disclosure and not intended to limit the present disclosure. Although the present disclosure is described in detail with reference to the preferred embodiments, those of ordinary skill in the art should understand that they can make modifications or equivalent substitutions to the technical solutions of the present disclosure without departing from the objective and scope of the technical solutions of the present disclosure. These modifications or equivalent substitutions should fall within the scope of the claims of the present disclosure.

What is claimed is:

1. A method for rapidly measuring tunnel blasting damage based on a wall-climbing robot, comprising the following steps:
S1. arranging a three-dimensional optical fiber network (20), recording the coordinates of each segment of optical fiber, and establishing a mapping relationship between an optical fiber node and a spatial coordinate position;
S2. constructing an initial three-dimensional wave velocity model of a tunnel rock mass;
S3. performing velocity spectrum analysis on a reflected wave and performing local correction on a diffracted wave, respectively, to obtain an optimized wave velocity model;
S4. exciting artificial seismic sources at a plurality of positions in the tunnel by the wall-climbing robot (10) with a vibration exciter (15), and performing data acquisition by a DAS system through the optical fiber network (20);
S5. processing data acquired in step S4, performing wave field separation on the reflected wave and the diffracted wave, and then performing migration imaging on the reflected wave and the diffracted wave, respectively; and
S6. fusing imaging results of the reflected wave and the diffracted wave by a weight coefficient to generate a comprehensive geological model.

2. The method for rapidly measuring tunnel blasting damage based on a wall-climbing robot according to claim 1, wherein step S2 specifically comprises the following steps:
S21. measuring a wave velocity of a tunnel lining material in a laboratory to serve as an initial model reference value;
S22. performing laboratory test on a drill core to obtain densities and wave velocities of different lithologies, correlating core data with the position of a drill spiral optical fiber, and establishing an initial vertical velocity gradient model;
S23. dividing a tunnel wall into a plurality of grids, moving the wall-climbing robot (10) to a center point of each grid according to a preset path, starting an electromagnetic vibration exciter (15) to generate an artificial seismic source, acquiring data by the DAS system through the optical fiber network (20) after each excitation, and recording the arrival time of a first-arrival wave at each optical fiber node to serve as first-arrival wave travel time data; and
S24. using a simultaneous iterative reconstruction technique to invert a large-scale velocity field of the rock mass to generate a three-dimensional wave velocity model.

3. The method for rapidly measuring tunnel blasting damage based on a wall-climbing robot according to claim 2, wherein in step S24, when the simultaneous iterative reconstruction technique is used, an iterative formula is as follows:
$${v}_{k + 1} = {v}_{k} + {λ}_{k} \cdot Ω \cdot {G}^{T} \cdot {Λ}^{- 1} \cdot ( {t}_{o b s} - \frac{G}{{v}_{k}} ) \qquad ( 1 )$$
a convergence condition is:
$$\frac{{‖ {t}_{o b s} - \frac{G}{{v}_{k}} ‖}_{2}}{{‖ {t}_{o b s} ‖}_{2}} ⩽ ε \qquad ( 2 )$$
in the formula, vₖ is a three-dimensional wave velocity field model of a k^{th} iteration, and an initial value wave velocity field v₀ is derived from drill core data and a lining material calibration value;
λₖ is an adaptive step length factor, that is, a dynamic attenuation coefficient for balancing a convergence velocity and a stability, λ₀ is an initial step length, and β is an attenuation rate;
Ω is a weight matrix which is a diagonal matrix with a dimension of A×A, A is the total number of rays, any element is expressed as
$${Ω}_{i i} = \frac{1}{\sqrt{{\sum }_{j} {G}_{i j}^{2} + γ}} ,$$
and γ=0.2·drill fracture density;
G is a ray path matrix which is a sparse matrix with a dimension of A×B, B is the total number of grids and used to describe a propagation path length of rays in the grids, an element Gᵢⱼ is a path length of an i^{th} ray in a j^{th} grid, and the ray path matrix G is generated based on the coordinates of a vibration exciting point of the wall-climbing robot (10) and the optical fiber node through ray tracing;
Λ is a path normalization matrix, and a diagonal element is a total path length ΣⱼGᵢⱼ of each ray and used to eliminate the influence of the ray path on a residual;
t_{obs} is first-arrival wave travel time data measured by the DAS system, and ε is a convergence threshold;
when the initial three-dimensional wave velocity model is generated, specific steps are as follows:
inputting the first-arrival wave travel time data t_{obs}, the ray path matrix G and the initial wave velocity field v₀ in an initial state, setting values of λ₀, β, γ and ε, and calculating the matrices Ω and Λ; and
calculating a residual
$${r}_{k} = {t}_{o b s} - \frac{G}{{v}_{k}} ,$$
calculating an updating quantity Δvₖ=λₖ·Ω·G^{T}·Λ⁻¹·rₖ, iteratively updating the wave velocity field vₖ₊₁=vₖ+Δvₖ, if not meeting the convergence condition of formula (2), continuing iteration until meeting the convergence condition of formula (2), outputting the current vₖ₊₁ to serve as the initial three-dimensional wave velocity model, and ending iteration.

4. The method for rapidly measuring tunnel blasting damage based on a wall-climbing robot according to claim 3, wherein in step S3, when the velocity field of the reflected wave is corrected, specific steps are as follows:
dividing reflected wave data into a plurality of common midpoint gathers based on the symmetrical distribution of the vibration exciting point and a receiving point, wherein the position of each common midpoint is the center of the position of the vibration exciting point of the wall-climbing robot (10) and the position of the receiving point in the optical fiber network (20), and each common midpoint gather corresponds to a reflected signal set of a specific area in front of the tunnel;
calculating superimposed energy corresponding to each candidate velocity through velocity scanning, and selecting a velocity corresponding to maximum energy as an optimal layer velocity of the current common midpoint, wherein a reflected wave velocity spectrum analysis formula is:
$$E ( V ) = {\sum }_{m = 1}^{M} {( {\sum }_{n = 1}^{N} {A}_{m n} \cdot δ ( {t}_{m n} - \sqrt{{t}_{0}^{2} + \frac{{x}_{n}^{2}}{{V}^{2}}} ) )}^{2} \qquad ( 3 )$$
in the formula, V is the candidate velocity, that is, a layer velocity value to be evaluated, E(V) is the superimposed energy corresponding to the candidate velocity V and used to evaluate the rationality of the velocity, M is the number of the common midpoint gathers, N is the number of seismic traces that each common midpoint gather comprises, Aₘₙ is an amplitude value in an n^{th} trace of seismic record in an m^{th} common midpoint gather and is directly measured by the DAS system, tₘₙ is the arrival time of an n^{th} trace of seismic wave in the m^{th} common midpoint gather, t₀ is the two-way time of the wave vertically incident to a reflecting interface from each common midpoint and back, xₙ is an offset distance, that is, a horizontal distance between a seismic source in the n^{th} trace of seismic record and the receiving point, δ is a pulse function and is used to align with a corrected waveform, δ is 1 only when time alignment and otherwise is 0, and
the convergence condition is: after a single-layer velocity is corrected, a change rate of the reflected wave superimposed energy is less than a convergence threshold κ, that is,
$$\frac{‖ {E ( V )}_{k + 1} - {E ( V )}_{k} ‖}{‖ {E ( V )}_{k} ‖} \leq κ ;$$
and
sequentially optimizing the velocity model from a shallow layer to a deep layer by a layer stripping method, recalculating the superimposed energy after each update until the velocity of each layer converges, and generating a calibrated velocity field of the reflected wave.

5. The method for rapidly measuring tunnel blasting damage based on a wall-climbing robot according to claim 4, wherein in step S3, when the velocity field of the diffracted wave is corrected, specific steps are as follows:
separating the diffracted wave by a polarization angle threshold, retaining a scattered signal with a polarization angle greater than 30°, and inhibiting reflected wave interference;
calculating a travel time residual of the diffracted wave by the following formula to compare measured travel time of the diffracted wave with predicted travel time of the current velocity field:
$$Δ t = {t}_{o b s} - \frac{{L}_{ray}}{{V}_{c u r r e n t}} \qquad ( 4 )$$
wherein in the formula, t_{obs} is the measured travel time of the diffracted wave measured by the DAS system, L_{ray} is a propagation path length of the diffracted wave and is calculated through ray tracing, and V_{current} is a local velocity of the current velocity field;
based on regularized least squares inversion, updating a local velocity anomalous area, solving the problem of blurred imaging of the diffracted wave, and performing reverse-time migration imaging by using a corrected local velocity field; and
in step S3, after correcting the velocity fields of the reflected wave and the diffracted wave, fusing the corrected local velocity field of the diffracted wave and the calibrated velocity field of the reflected wave to generate an optimized wave velocity model.

6. The method for rapidly measuring tunnel blasting damage based on a wall-climbing robot according to claim 5, wherein in step S4, specifically, based on the grids divided in step S23, the tunnel wall is divided into a plurality of finer grids, the wall-climbing robot (10) moves to each grid midpoint according to a preset path, the electromagnetic vibration exciter (15) is started to generate the artificial seismic source, after each vibration excitation, the DAS system records full waveform data of the optical fiber network (20), comprising a direct wave, the reflected wave and the diffracted wave, and the vibration exciting time of the robot and the acquisition time of the DAS system are synchronized by an optical fiber timing technology.

7. The method for rapidly measuring tunnel blasting damage based on a wall-climbing robot according to claim 6, wherein step S5 specifically comprises the following steps:
first, preprocessing data, determining the arrival time of the first-arrival wave by detecting a mutation point of a waveform amplitude, eliminating a delayed signal and non-seismic source interference, and performing data denoising and signal gain;
then, separating the reflected wave and the diffracted wave, separating the diffracted wave based on the polarization angle threshold, retaining a scattered signal with a polarization angle greater than 30°, retaining a nearly vertical incident component of the reflected wave, filtering out a high-frequency diffracted wave component in a frequency-wave number domain, and retaining a low-frequency reflected wave signal;
when performing reflected wave migration imaging, according to the optimized wave velocity model obtained in step S3, weighting and superimposing the reflected wave amplitude to an imaging point according to the travel time and by a Kirchhoff integral method, as the following formula:
$${I}_{r e f lection} ( x , z ) = {\sum }_{i = 1}^{N} \frac{{A}_{i}}{\sqrt{V ( x , z ) {t}_{i}}} \cdot δ ( {t}_{i} - \frac{{r}_{s i} + {r}_{r i}}{V ( x , z )} ) \qquad ( 5 )$$
wherein in the formula, Aᵢ is a reflected wave amplitude from a seismic source point Sᵢ to a receiving point Rᵢ, rₛᵢ is a distance from the seismic source point Sᵢ to an imaging point (x, z), rᵣᵢ is a distance from the receiving point Rᵢ to the imaging point (x, z), and V(x, z) is a calibrated velocity field;
analyzing a dynamic optimization velocity field by a residual curvature until the imaging of the reflecting interface is clear;
when performing diffracted wave migration imaging, according to the optimized wave velocity model obtained in step S3, accurately capturing an asymmetric path of the diffracted wave by a reverse-time migration algorithm and through full-wave field forward-backward propagation interference imaging, as the following formula:
I_{diffraction}(x,z)=Σₜ[forward−propagated wave field(x,z,t)·backward−propagated wave field(x,z,t)] (6)
wherein in the formula, a forward-propagated wave field refers to a wave field propagated forward from the seismic source point, and a backward-propagated wave field is a wave field propagated backward from the receiving point; and
subsequently, correcting the local velocity, for a diffracted imaging blurred area, inverting local velocity anomaly based on the travel time residual, and performing migration imaging again after updating.

8. The method for rapidly measuring tunnel blasting damage based on a wall-climbing robot according to claim 7, wherein in step S6, imaging results of the reflected wave and the diffracted wave are fused by the weight coefficient to generate the comprehensive geological model, as expressed by the following formula:
I_{final}(x,Z)=α·I_{refection}(x,Z)+β·I_{diffraction}·(x,z) (7)
in the formula, α and β are weight coefficients, and α+β=1.

9. A system for rapidly measuring tunnel blasting damage based on a wall-climbing robot, using the method for rapidly measuring tunnel blasting damage based on a wall-climbing robot according to claim 8 and comprising a DAS system and the wall-climbing robot (10), wherein
the DAS system comprises an optical fiber network (20) and a demodulator (30), the optical fiber network (20) is configured to receive a vibration signal, and the demodulator (30) is configured to extract related information by analyzing a waveform of the vibration signal;
the wall-climbing robot (10) comprises a main body (11), and a plurality of rotor wings (12), a plurality of driving wheels (13), a vacuum pump (14) and a vibration exciter (15) which are mounted on the main body (11); and
the rotor wings (12) and the vacuum pump (14) are, respectively, configured to provide a lift force and an adsorption force, the plurality of driving wheels (13) are used for the wall-climbing robot (10) to walk on a tunnel wall, and the vibration exciter (15) is configured to generate an artificial seismic source.

10. The system for rapidly measuring tunnel blasting damage based on a wall-climbing robot according to claim 9, wherein the wall-climbing robot (10) is further provided with a navigation module, a camera module (16) and a data transmission module;
the navigation module is configured to plan a movement path, the camera module (16) is configured to identify the quality of a lining on a surface of a tunnel, and the data transmission module is configured to achieve remote control and transmit navigation information and video information to a mobile terminal in real time;
the optical fiber network (20) comprises circumferential optical fibers (21), longitudinal optical fibers (22) and spiral winding optical fibers (23);
the circumferential optical fibers (21) are arranged at equal intervals in a circumferential direction of the tunnel wall to form a closed ring and cover the full cross-section of the tunnel;
the longitudinal optical fibers (22) are arranged in parallel in an axial direction of the tunnel and orthogonal to the circumferential optical fibers (21) to form a grid; and
when the spiral winding optical fibers (23) are arranged, the tunnel wall is drilled first, and then the optical fibers are embedded into drill holes in a spiral winding manner.
